(19) United States
(12) Patent Application Publication
(10) Pub. No.: US 2024/0244437 A1
(43) Pub. Date: Jul. 18, 2024

(54) SYSTEMS AND METHODS FOR HANDLING ABNORMAL ACTIVITY IN O-RAN NEAR REAL TIME RIC PLATFORM

(71) Applicants: RAKUTEN SYMPHONY SINGAPORE PTE. LTD., Singapore (SG); RAKUTEN MOBILE, INC., Tokyo (JP)

(72) Inventors: Prabhu KALISWAMY, Indore (IN); Raghavendran RAMIYA, Indore (IN); Ritesh Kumar KALLE, Tokyo (JP)

(73) Assignees: RAKUTEN SYMPHONY SINGAPORE PTE. LTD., Singapore (SG); RAKUTEN MOBILE, INC., Tokyo (JP)

(21) Appl. No.: 18/012,483

(22) PCT Filed: Nov. 14, 2022
(86) PCT No.: PCT/US2022/049758

§ 371 Date: Dec. 22, 2022

Related U.S. Application Data
(60) Provisional application No. 63/399,434, filed on Aug. 19, 2022.

(51) Int. Cl. H04W 12/128

(52) U.S. Cl. CPC H04W 12/128

(57) ABSTRACT

A method performed by at least one processor includes detecting an onboarding of an application. The method further includes determining one or more application properties of the application in response to the detecting. The method further includes generating a protection program based on the one or more application properties. The method further includes deploying the protection program. The protection program provides a mitigation action in response to a detection of an attack on the application.

### CROSS-REFERENCE TO RELATED APPLICATION(S)

This application is based on and claims priority from U.S. Provisional Patent Application No. 63/399,434, filed on Aug. 19, 2022, the disclosure of which is incorporated by reference herein in its entirety.

### TECHNICAL FIELD

Apparatuses and methods consistent with example embodiments of the present disclosure relate to a framework for providing real-time detection and resolution of abnormal activities in the Radio Access Network (RAN) intelligent controller (RIC) platform.

### BACKGROUND

The related art O-RAN specification does not provide internal or functional aspects or definitions of a security service in the near real time (near-RT) radio access network (RAN) intelligent controller (RIC). Thus, the related art O-RAN architecture does not incorporate a solution for threats or malware attacks (e.g., volumetric attacks, misbehavior, etc.) of near-RT RIC (e.g., hosted application (xApp), etc.).

The most commonly used solution for volumetric attacks in the related art runs sidecar proxies alongside a core container of each component/service in the container platform. This solution, however, requires high latency and increased operational complexity and resource utilization (e.g., memory, random access memory (RAM), storage spaces, etc.). As a result, implementing this solution in the RIC platform cannot detect and mitigate/handle attacks such as volumetric attacks and file system operation attacks in real time.

Therefore, there exists a need for detecting and mitigating attacks triggered by a malicious actor towards the RAN and RIC platform from compromised RIC applications (xApps) and compromised devices (e.g., user equipment (UE) and Internet of Things (IOT) devices).

Improvements are presented herein. These improvements may also be applicable to other multi-access technologies and the telecommunication standards that employ these technologies.

### SUMMARY

The following presents a simplified summary of one or more embodiments of the present disclosure in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

Methods, apparatuses, and non-transitory computer-readable mediums for providing real-time detection and resolution of abnormal activities in the RAN RIC platform.

According to exemplary embodiments, a method performed by at least one processor includes detecting an onboarding of an application. The method further includes determining one or more application properties of the application in response to the detecting. The method further includes generating a protection program based on the one or more application properties. The method further includes deploying the protection program. The protection program provides a mitigation action in response to a detection of an attack on the application.

According to exemplary embodiments, a network node operating in a wireless communication network includes at least one memory configured to store computer program code and at least one processor configured to access said at least one memory and operate as instructed by the computer program code. The computer program code includes detecting code configured to cause at least one of said at least one processor to detect an onboarding of an application. The computer program code includes determining code configured to cause at least one of said at least one processor to determine one or more application properties of the application in response to the detecting. The computer program code includes generating code configured to cause at least one of said at least one processor to generate a protection program based on the one or more application properties. The computer program code further includes deploying code configured to cause at least one of said at least one processor to deploy the protection program. The protection program provides a mitigation action in response to a detection of an attack on the application.

Additional embodiments will be set forth in the description that follows and, in part, will be apparent from the description, and/or may be learned by practice of the presented embodiments of the disclosure.

### BRIEF DESCRIPTION OF THE DRAWINGS

The above and other aspects, features, and aspects of embodiments of the disclosure will be apparent from the following description taken in conjunction with the accompanying drawings, in which:

FIG. 1 is a diagram of an example network device in accordance with various embodiments of the present disclosure;

FIG. 2 is a schematic diagram of an example O-RAN communications system, in accordance with various embodiments of the present disclosure;

FIG. 3 illustrates an example RIC architecture, in accordance with various embodiments of the present disclosure;

FIG. 4 illustrates an example RIC platform, in accordance with various embodiments of the present disclosure; and

FIG. 5 illustrates a flowchart of an attack detection and mitigation process, in accordance with various embodiments of the present disclosure.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

Embodiments of the present disclosure are directed to a real time Security Monitoring and Control framework (SMCF). In some embodiments, the SMCF may be provided in the O-RAN near-RT RIC platform layer to identify various attacks. The attacks may include volumetric attacks on xApps, compromised xApps, misbehavior and misconfiguration of xApps, etc. These attacks may degrade the near-RT RIC performance.

The identified risks may be mitigated by enforcing run-time policies or isolating the affected services/applications as a preventive action. These policies may also expose the API towards Northbound (NB) for the Security xApp, which needs any kind of metrics/events for offline analysis (e.g., ML related attacks). Furthermore, the Security xApp may provide policy guidance or rules to the RIC SMCF.

In some embodiments, the SMCF prepares one or more protection programs based on application properties. The protection program may be prepared using extended Berkley Packet Filter (eBPF)+eXpress Data Path (XDP) frameworks. These protection programs may be configured with one or more detection/rule patterns to detect an attack on an application. For example, these protection programs may be used to detect various attacks such as volumetric attacks. These protection programs may also be configured to capture file system events (e.g., open/read/write) and subsequently load the captured events in an eBPF space to detect an attack.

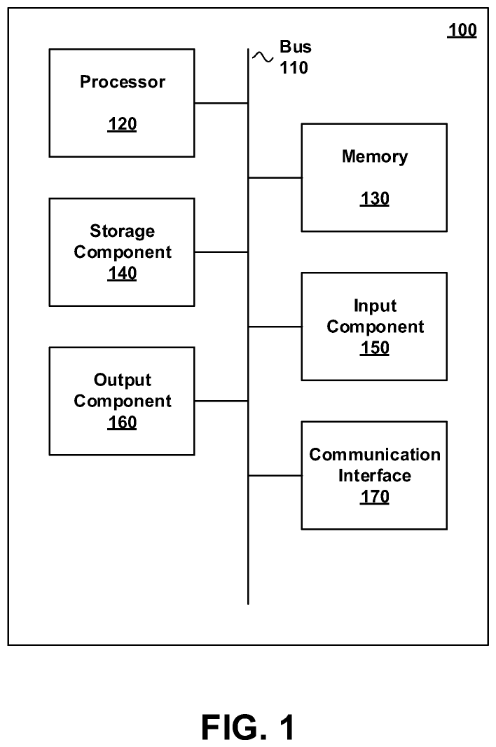

FIG. 1 is diagram of an example device 100 for implementing the methods of the present disclosure. Device 100 may implement the SMCF. Device 100 may correspond to any type of known computer, server, or data processing device. For example, the device 100 may comprise a processor, a personal computer (PC), a printed circuit board (PCB) comprising a computing device, a mini-computer, a mainframe computer, a microcomputer, a telephonic computing device, a wired/wireless computing device (e.g., a smartphone, a personal digital assistant (PDA)), a laptop, a tablet, a smart device, or any other similar functioning device.

In some embodiments, as shown in FIG. 1, the device 100 may include a set of components, such as a processor 120, a memory 130, a storage component 140, an input component 150, an output component 160, and a communication interface 170.

The bus 110 may comprise one or more components that permit communication among the set of components of the device 100. For example, the bus 110 may be a communication bus, a cross-over bar, a network, or the like. Although the bus 110 is depicted as a single line in FIG. 1, the bus 110 may be implemented using multiple (two or more) connections between the set of components of device 100. The disclosure is not limited in this regard.

The device 100 may comprise one or more processors, such as the processor 120. The processor 120 may be implemented in hardware, firmware, and/or a combination of hardware and software. For example, the processor 120 may comprise a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), a general purpose single-chip or multi-chip processor, or other programmable logic device, discrete gate or transistor logic, discrete hardware components, or any combination thereof designed to perform the functions described herein. A general purpose processor may be a microprocessor, or any conventional processor, controller, microcontroller, or state machine. The processor 120 also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function.

The processor 120 may control overall operation of the device 100 and/or of the set of components of device 100 (e.g., the memory 130, the storage component 140, the input component 150, the output component 160, the communication interface 170).

The device 100 may further comprise the memory 130. In some embodiments, the memory 130 may comprise a random access memory (RAM), a read only memory (ROM), an electrically erasable programmable ROM (EEPROM), a flash memory, a magnetic memory, an optical memory, and/or another type of dynamic or static storage device. The memory 130 may store information and/or instructions for use (e.g., execution) by the processor 120.

The storage component 140 of device 100 may store information and/or computer-readable instructions and/or code related to the operation and use of the device 100. For example, the storage component 140 may include a hard disk (e.g., a magnetic disk, an optical disk, a magneto-optic disk, and/or a solid state disk), a compact disc (CD), a digital versatile disc (DVD), a universal serial bus (USB) flash drive, a Personal Computer Memory Card International Association (PCMCIA) card, a floppy disk, a cartridge, a magnetic tape, and/or another type of non-transitory computer-readable medium, along with a corresponding drive.

The device 100 may further comprise the input component 150. The input component 150 may include one or more components that permit the device 100 to receive information, such as via user input (e.g., a touch screen, a keyboard, a keypad, a mouse, a stylus, a button, a switch, a microphone, a camera, and the like). Alternatively or additionally, the input component 150 may include a sensor for sensing information (e.g., a global positioning system (GPS) component, an accelerometer, a gyroscope, an actuator, and the like).

The output component 160 of device 100 may include one or more components that may provide output information from the device 100 (e.g., a display, a liquid crystal display (LCD), light-emitting diodes (LEDs), organic light emitting diodes (OLEDs), a haptic feedback device, a speaker, and the like).

The device 100 may further comprise the communication interface 170. The communication interface 170 may include a receiver component, a transmitter component, and/or a transceiver component. The communication interface 170 may enable the device 100 to establish connections and/or transfer communications with other devices (e.g., a server, another device). The communications may be effected via a wired connection, a wireless connection, or a combination of wired and wireless connections. The communication interface 170 may permit the device 100 to receive information from another device and/or provide information to another device. In some embodiments, the communication interface 170 may provide for communications with another device via a network, such as a local area network (LAN), a wide area network (WAN), a metropolitan area network (MAN), a private network, an ad hoc network, an intranet, the Internet, a fiber optic-based network, a cellular network (e.g., a fifth generation (5G) network, a long-term evolution (LTE) network, a third generation (3G) network, a code division multiple access (CDMA) network, and the like), a public land mobile network (PLMN), a telephone network (e.g., the Public Switched Telephone Network (PSTN)), or the like, and/or a combination of these or other types of networks. Alternatively or additionally, the communication interface 170 may provide for communications with another device via a device-to-device (D2D) communication link, such as FlashLinQ, WiMedia, Bluetooth, ZigBee, Wi-Fi, LTE, 5G, and the like. In other embodiments, the communication interface 170 may include an Ethernet interface, an optical interface, a coaxial interface, an infrared interface, a radio frequency (RF) interface, or the like.

The device 100 may be included in the core network 240 and perform one or more processes described herein. The device 100 may perform operations based on the processor 120 executing computer-readable instructions and/or code that may be stored by a non-transitory computer-readable medium, such as the memory 130 and/or the storage component 140. A computer-readable medium may refer to a non-transitory memory device. A memory device may include memory space within a single physical storage device and/or memory space spread across multiple physical storage devices.

Computer-readable instructions and/or code may be read into the memory 130 and/or the storage component 140 from another computer-readable medium or from another device via the communication interface 170. The computer-readable instructions and/or code stored in the memory 130 and/or storage component 140, if or when executed by the processor 120, may cause the device 100 to perform one or more processes described herein.

Alternatively or additionally, hardwired circuitry may be used in place of or in combination with software instructions to perform one or more processes described herein. Thus, embodiments described herein are not limited to any specific combination of hardware circuitry and software.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally or alternatively, a set of (one or more) components shown in FIG. 1 may perform one or more functions described as being performed by another set of components shown in FIG. 1.

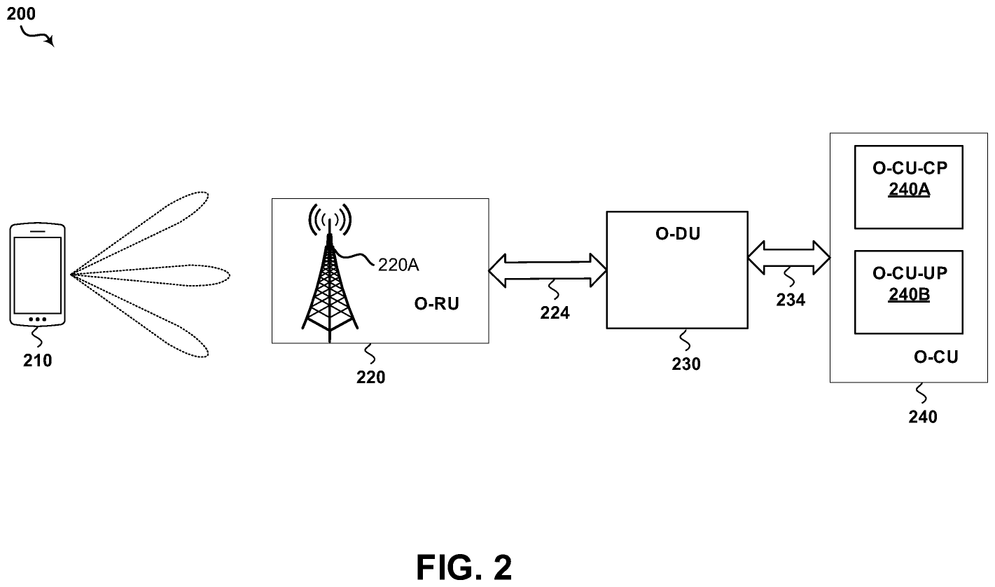

FIG. 2 is a diagram illustrating an example O-RAN communication system 200, according to various embodiments of the present disclosure. The O-RAN communication system 200 may include one or more user equipment (UE) 210, one or more O-RAN Radio Units (O-RU) 220, one or more O-RAN Distribution Units (O-DU) 230, and one or more O-RAN Centralized Units (O-CU) 240.

Examples of UEs 210 may include a cellular phone, a smart phone, a session initiation protocol (SIP) phone, a laptop, a personal digital assistant (PDA), a satellite radio, a global positioning system (GPS), a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similarly functioning device. Some of the one or more UEs 210 may be referred to as Internet-of-Things (IOT) devices (e.g., parking meter, gas pump, toaster, vehicles, heart monitor, etc.). The one or more UEs 210 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile agent, a client, or some other suitable terminology.

The O-RU 220 connects with one or more cells 220a (e.g., antennas) in a site. The one or more cells 220A may wirelessly communicate with the one or more UEs 210. Each cell of the one or more cells 220A may provide communication coverage to one or more UEs 210 located within a geographic coverage area of that cell 220A. In some embodiments, as shown in FIG. 2, the cell 220A may transmit one or more beamformed signals to the one or more UEs 210 in one or more transmit directions. The one or more UEs 210 may receive the beamformed signals from the cell 220A in one or more receive directions. Alternatively or additionally, the one or more UEs 210 may transmit beamformed signals to the cell 220 in one or more transmit directions. The cell 220A may receive the beamformed signals from the one or more UEs 210 in one or more receive directions.

The one or more cells 220A may include macrocells (e.g., high power cellular base stations) and/or small cells (e.g., low power cellular base stations). The small cells may include femtocells, picocells, and microcells. A cell 220A, whether a macrocell or a large cell, may include and/or be referred to as an access point (AP), an evolved (or evolved universal terrestrial radio access network (E-UTRAN)) Node B (eNB), a next-generation Node B (gNB), or any other type of base station known to one of ordinary skill in the art. In some embodiments, the cell 220A includes a cellular antenna.

In some embodiments, the O-RU 220 may be connected to the O-DU 230 via a FH link 224. The FH link may be a 25 Gbps line in which User Plane (U-plane) and Control Plane (C-Plane) packets are downloaded from the O-DU 230 to the O-RU 220. In some embodiments, the O-DU 230 may be connected to the O-CU 240 via a midhaul link 234. The O-CU 240 may include an O-CU Control Plane (O-CU-CP) packet generator 240A and an O-CU User Plane (O-CU-UP) packet generator 240B. C-plane and U-plane packets may originate from the O-CU-CP packet generator 240A and the O-CU-UP packet generator 240B, respectively.

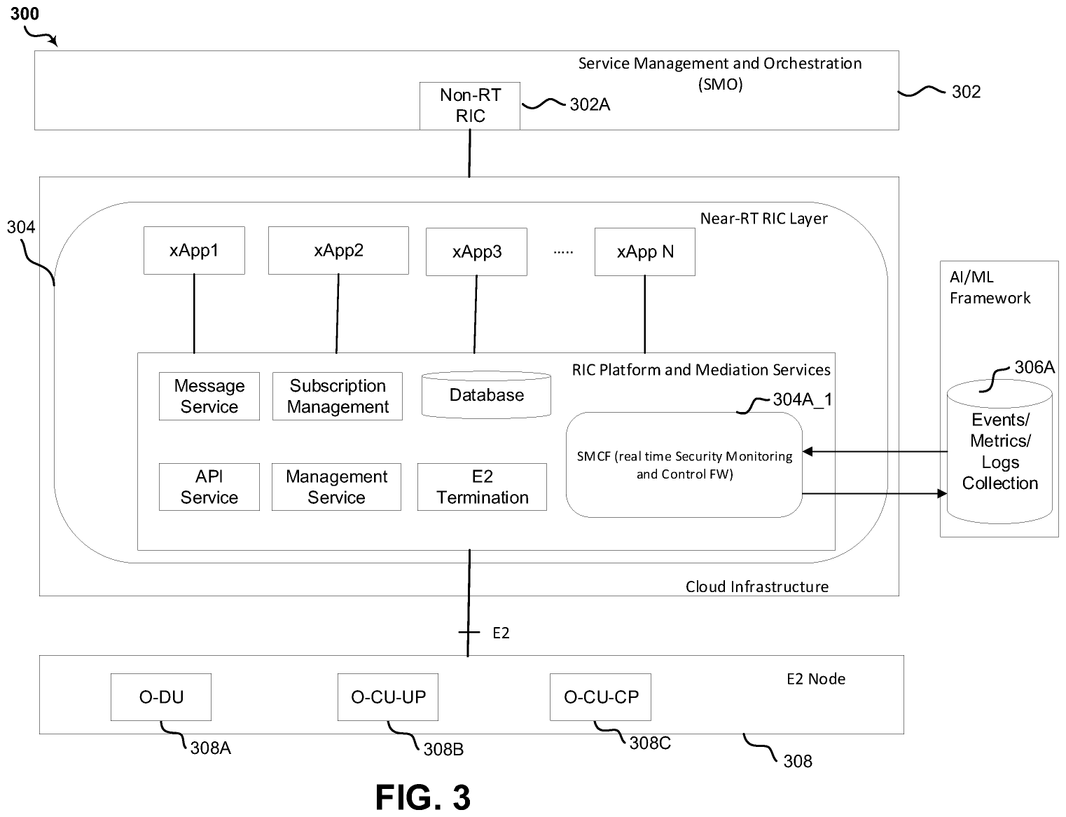

FIG. 3 illustrates an example of a high level RIC architecture 300 with xApp deployment. The high level RIC architecture may include a Service management and Orchestration (SMO) layer 302, a near-RT RIC layer 304, an Artificial Intelligence/Machine Learning (AI/ML) Framework layer 306, and a node layer 308. The SMO layer 302A may include a non-RT RIC 302A. The near-RT layer 304 may include xApps such as xApp1 to xAppN. The near-RT layer 304 may also include a RIC platform 304A that includes one or more services (e.g., Message Service, Subscription Management, API service, Management Service, Database, E2 Termination, etc.) as well as the SMCF 304A_1. The near-RT RIC layer 304 may interface with the SMO layer 302 via an A1 interface. The node layer 308 may correspond to an E2 node and may include an O-DU 308A, an O-CU-UP 308B, and an O-CU-CP 308C, which may correspond to the O-DU 230, O-CU-CP 240A, and the O-CU-UP 240B, respectively. The node layer 308 may interface with the near-RT-RIC layer 304 via an E2 interface. The AI/ML Framework layer 306 may include a database 306A for storing events, metrics, and collection logs.

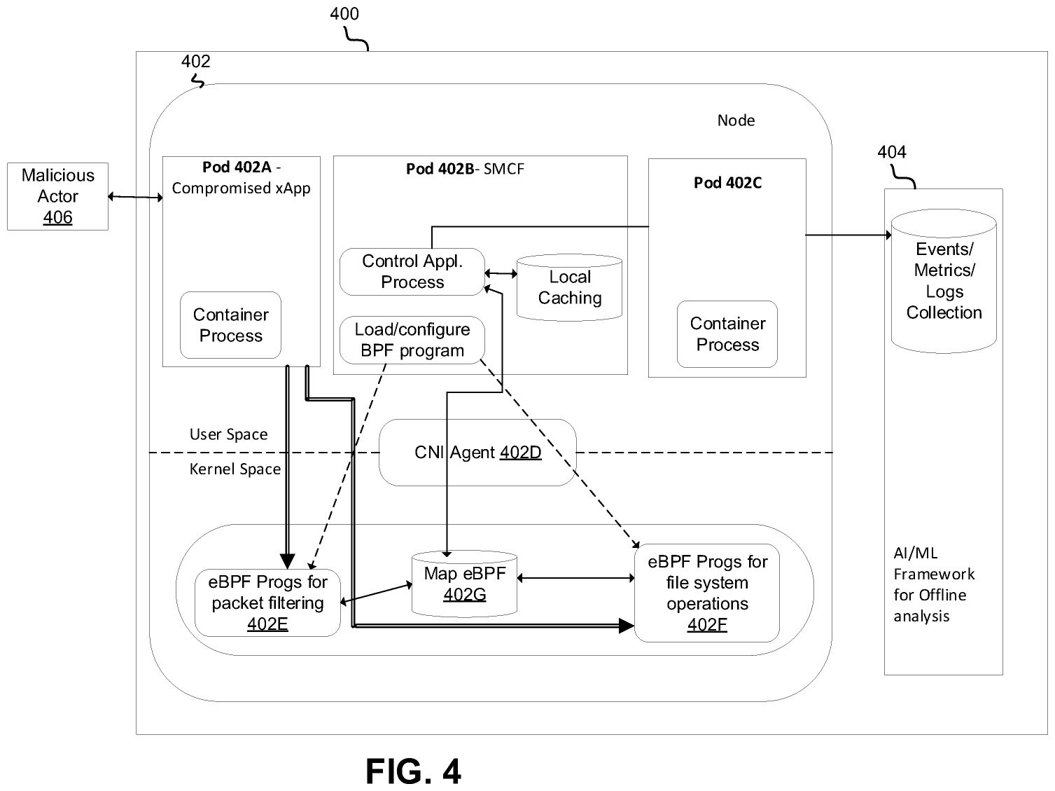

FIG. 4 illustrates an example RIC Platform 400 that includes Node 402 and AI/ML Framework 404. The AI/ML Framework 404 may correspond to the AI/ML Framework layer 306 (FIG. 3). Node 402 may include a number of pods such as Pod 402A, Pod 402B, and Pod 402C. The Pod 402A may correspond to a compromised xApp that is attacked by malicious actor 406. The Pod 402B may contain the SMCF, which may correspond to SMCF 304A_1. In some embodiments, when an attack is detected, the affected application may be isolated. For example, the xApp corresponding to Pod 402A may be isolated from the other xApps.

The RIC platform 400 may also include a Container Network Interface (CNI) Agent 402D. In some embodiments, the SMCF uses a CNI agent such as CNI Agent 402D to collect each application's (e.g., RIC xApps) properties. These application properties may include an application's identity (e.g., container identity), services, running processes of the corresponding Pod/Container, and existing network policy.

The Pod 402B may deploy eBPF 402e and/or eBPF 402F. The eBPF 402E may include packet filtering options that drop or pass packets based on an inspection of the packet. The eBPF 402F may include file system operation functions for blocking unauthorized file system operations. The eBPF 402E and the eBPF 402F may communicate with Map eBPF 402G. For example, the eBPF 402E may read from the Map eBPF 402G a packet count based on a protocol type and source/destination port, which may be used to detect any abnormal behavior in the incoming network traffic. The Pod 402B (SMCF) may create and update the Map eBPF 402G. The Pod 402B (SMCF) may further read data/information from the Map eBPF 402G for offline analysis. In some embodiments, the eBPF program may be updated in real time. For example, after deploying the eBPF program, if any of the retrieved application properties change (e.g., list of blacklisted ports changes), the eBPF program may be updated in real time. Therefore, the eBPF may be dynamically updated with policies or rules.

In some embodiments, if the eBPF program (such as eBPF 402E) detects any abnormality or sudden spike of network traffic or resource consumption, then the eBPF program may apply an enforcement rule if the attack is detected as a volumetric attack or prepare a policy in real-time to mitigate or take a preventive action. In some embodiments, the eBPF program (such as eBPF 402E) may comprise an eBPF eXpress Data Path (XDP) program, which may parse an incoming IP packet and check for characteristics like an IP transport, protocol type, port, and target subnet, and validate against static blacklisted IP address/subnet and ports to detect a volumetric attack. For example, the eBPF program may be configured with a list of blacklisted protocol types or ports, and if an incoming packet specifies a protocol type or port included on the blacklist, then an attack is detected. When an attack is detected, the eBPF program may take a mitigation or preventative action such as dropping the inspected packet. An example instruction implemented by the eBPF XDP program for such detecting and handling of a volumetric attack is provided below:

```
if (h_proto == htons(ETH_P_IP)) {
  if (iph−>protocol == IPPROTO_UDP // Protocol type − TCP or UDP
    && udph−>dest == htons(1243)) && udph−>src == htons(2432)) {
      return XDP_DROP;
  }
}
```

In the above example, a blacklist may specify that a packet should be dropped if the packet is an Ethernet packet, specifies a UDP protocol, specifies a destination port as “1234,” and specifies a source port as “2432.” Accordingly, in the above example, a value of “XDP_DROP” is returned indicating the inspected packet should be dropped.

In certain volumetric cases, the loaded eBPF program may count and categorize incoming packets based on destination/source ports and protocol type and check whether the counter value is exceeding a MAX threshold limit periodically (e.g., every 500 ms). If the counter value crosses the max limit, then a relevant filter rule may be applied to block/drop the targeted packets. As an example, if a number of inspected packets are received within a predetermined time period, then a volumetric attack may be detected. As another example, if a number of inspected packets with a specific destination/source port and/or protocol type are received within a predetermined time period, then a volumetric attack may be detected.

In some embodiments, the eBPF program may be enhanced to collect a measurement such as a packet drop count and packet count with a specific port and/or protocol type. Detecting a volumetric attack may be performed as follows:

```
MAX_THRESHOLD_LIMIT=10000.  if (iph−>protocol == IPPROTO_UDP  &&
udph−>dest == htons(1234)) && counter >= MAX_THRESHOLD_LIMIT) {
    return XDP_DROP;
  }
```

In the above example, if the number of packets that specify the UDP protocol and a destination port as “1234” exceed the threshold limit (e.g., MAX_THRESHOLD_LIMIT) of 10000 within a predetermined time period, then a volumetric attack is detected and a value of “XDP_DROP” is returned indicating that one or more packets should be dropped. The threshold limit is not fixed, and may be adjusted to an appropriate value as required. The protocol type may be TCP or UDP.

In some embodiments, for file system operations, if the detection rule is added to monitor events when the system files are targeted to change/update with wrong information, the eBPF program such as eBPF 402F may detect and apply a rule to block/exit the file system operation. For example, an attack may be detected if a file system operation involves an unknown process or modifies a file with incorrect information. Detecting a file system operation attack may be performed as follows:

if (file.open.path == “/etc/shadow” && file.process.path not in [“/usr/bin/system”,
“/usr/bin/docker”]) {
Return −1 //Block or Exit the operation if unknown process
}

In the above example, the processes associated with the “system” and “docker” may be specified in a list of known processes. Accordingly, if a file system operation specifies a process other than “system” or “docker,” an attack may be detected, and the file system operation may be blocked or exited.

In some embodiments, a process execution event may be detected and blocked by adding a detection rule for a selective or critical process. The embodiments of the present disclosure ensure that the RAN RIC platform and applications are not adversely affected by a volumetric attack and recover immediately without compromising and disturbing core functionality of the system in near real-time. The SMCF, through its generated/configured and deployed eBPF programs according to example embodiments, may detect and mitigate these attacks or take preventive action in near real-time within the latency requirement defined for O-RAN near-RT RIC.

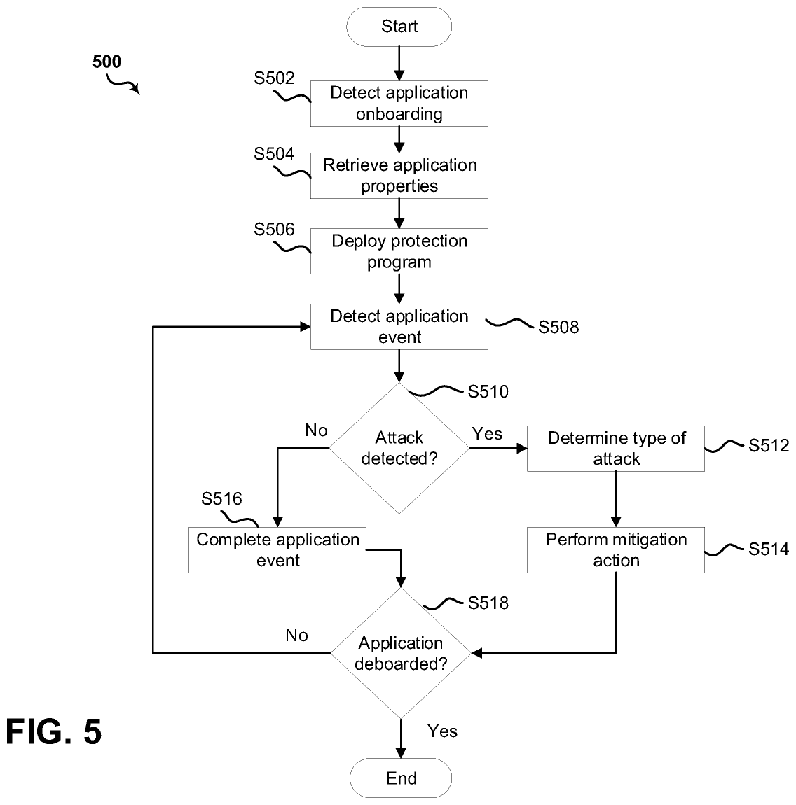

FIG. 5 is a flow chart that illustrates an embodiment of an attack detection and mitigation process 500. The process 500 may be performed for each application onboarded onto an RIC platform such as RIC platform 304 (FIG. 3). The process 500 may be performed by device 100 (FIG. 1). The process 500 may start at step S502 where an onboarding of an application such as an xApp may be detected. For example, the onboarding of any one of xApp1 to xAppN (FIG. 3) may be detected. The process proceeds to step S504 where application properties of the application are retrieved. For example, the application properties may include the application identity, list of blacklisted ports, list of blacklisted transport protocols, list of known processes, etc. In other examples, the application properties may include a list of approved ports, a list of approved transport protocols, etc.

The process proceeds to step S506 where a protection program such as an eBPF is deployed. The eBPF may correspond to eBPF 402E or eBPF 402F (FIG. 4). The eBPF may be configured based on the retrieved application properties. For example, if the retrieved properties includes a list of approved ports, the eBPF may be configured to drop a packet that specifies a port not included on the list. The process proceeds to step S508 where an application event is detected. The application event may correspond to a reception of a packet, a file system operation, or a network operation.

The process proceeds to step S510 where it is determined if an attack is detected. The detection of an attack may be based on a detection of abnormal application behavior, a spike in traffic within a predetermined time period, or an improper file system operation. If the attack is detected, the process proceeds to step S512 where the type of attack is determined. For example, the process may determine whether the attack is a volumetric attack or an improper file system operation. The process proceeds to step S514 where a mitigation action is performed. For example, the mitigation action may include dropping a packet for a volumetric attack or blocking a file system operation for a file system attack.

If at step S510 the attack is not detected, the process proceeds to step S516 where the application event is completed without any mitigation action performed by the protection program. The process proceeds from step S514 or from step S516 to step S518 where it is determined if the application is deboarded. If the application is not deboarded, the process returns to step S508. If the application is deboarded, the process illustrated in FIG. 5 terminates.

The foregoing disclosure provides illustration and description, but is not intended to be exhaustive or to limit the implementations to the precise form disclosed. Modifications and variations are possible in light of the above disclosure or may be acquired from practice of the implementations.

It is understood that the specific order or hierarchy of blocks in the processes/flowcharts disclosed herein is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

The above disclosure also encompasses the embodiments listed below:

(1) A method performed by at least one processor, the method includes: detecting an onboarding of an application; determining one or more application properties of the application in response to the detecting; generating a protection program based on the one or more application properties; and deploying the protection program, in which the protection program provides a mitigation action in response to a detection of an attack on the application.

(2) The method according to feature (1), in which the detection of the attack on the application includes the protection program inspecting a received packet, and in which the mitigation action includes dropping the received packet in response to the detection of the attack based on the inspection.

(3) The method according to feature (2), in which the application properties includes a list of ports, and in which the detection of the attack occurs in response to a determination, based on the inspection, that the received packet specifies a port not included in the list of ports.

(4) The method according to feature (2), in which the application properties includes a list of transport protocols, and in which the detection of the attack occurs in response to a determination, based on the inspection, that the received packet specifies a transport protocol not included in the list of transport protocols.

(5) The method according to feature (2), in which the application properties includes a list of target subnets, and in which the detection of the attack occurs in response to a determination, based on the inspection, that the received packet specifies a target subnet not included in the list of target subnets.

(6) The method according to any one of features (1)-(5), in which the one or more application properties includes list of predetermined processes of the application, in which the detection of the attack on the application occurs in response to detection of execution of a process not included in the list of predetermined processes, and in which the mitigation action includes blocking the process not included in the list of predetermined processes.

(7) The method according to any one of features (1)-(6), in which the one or more application properties includes a list of approved modifications to the application, in which the detection of the attack on the application occurs in response to detection of a modification to the application not included in the list of approved modifications, and in which the mitigation action includes blocking the modification to the application not included in the list of approved modifications.

(8) The method according to any one of features (1)-(7), in which the detection of the attack on the application occurs in response to a detection of receiving a number packets within a time period that exceeds a threshold, and in which the mitigation action includes blocking one or more packets received within the time period.

(9) The method according to feature (8), in which the detection of the attack on the application occurs in response to a detection of receiving a number packets having a predetermined destination and source within a time period that exceeds a threshold.

(10) The method according to feature (8), in which the detection of the attack on the application occurs in response to a detection of receiving a number packets having a predetermined protocol type within a time period that exceeds a threshold.

(11) The method according to any one of features (1)-(10), further including, after deploying the protection program, determining a new property of the application; and adjusting one or more rules of the protection program.

(12) The method according to any one of features (1)-(11), further including removing the protection program in response to a determination the application is removed.

(13) The method according to any one of features (1)-(12), in which the protection program is an extended Berkley Packet Filter (eBPF).

(14) A network node operating in a wireless communication network, the network node includes: at least one memory configured to store computer program code; and at least one processor configured to access said at least one memory and operate as instructed by said computer program code, said computer program code including: detecting code configured to cause at least one of said at least one processor to detect an onboarding of an application, determining code configured to cause at least one of said at least one processor to determine one or more application properties of the application in response to the detecting, generating code configured to cause at least one of said at least one processor to generate a protection program based on the one or more application properties, and deploying code configured to cause at least one of said at least one processor to deploy the protection program, in which the protection program provides a mitigation action in response to a detection of an attack on the application.

(15) The network node according to feature (14), in which the detection of the attack on the application includes the protection program inspecting a received packet, and in which the mitigation action includes dropping the received packet in response to the detection of the attack based on the inspection.

(16) The network node according to feature (15), in which the application properties includes a list of ports, and in which the detection of the attack occurs in response to a determination, based on the inspection, that the received packet specifies a port not included in the list of ports.

(17) The network node according to feature (15), in which the application properties includes a list of transport protocols, and in which the detection of the attack occurs in response to a determination, based on the inspection, that the received packet specifies a transport protocol not included in the list of transport protocols.

(18) The network node according to feature (15), in which the application properties includes a list of target subnets, and in which the detection of the attack occurs in response to a determination, based on the inspection, that the received packet specifies a target subnet not included in the list of target subnets.

(19) The network node according to any one of features (14)-(18), in which the one or more application properties includes list of predetermined processes of the application, in which the detection of the attack on the application occurs in response to detection of execution of a process not included in the list of predetermined processes, and in which the mitigation action includes blocking the process not included in the list of predetermined processes.

(20) A non-transitory computer readable medium having instructions stored therein, which when executed by a processor cause the processor to execute a method including: detecting an onboarding of an application; determining one or more application properties of the application in response to the detecting; generating a protection program based on the one or more application properties; and deploying the protection program, in which the protection program provides a mitigation action in response to a detection of an attack on the application.

What is claimed is:

1. A method performed by at least one processor, the method comprising:
detecting an onboarding of an application;
determining one or more application properties of the application in response to the detecting;
generating a protection program based on the one or more application properties; and
deploying the protection program,
wherein the protection program provides a mitigation action in response to a detection of an attack on the application.

2. The method according to claim 1, wherein the detection of the attack on the application includes the protection program inspecting a received packet, and wherein the mitigation action includes dropping the received packet in response to the detection of the attack based on the inspection.

3. The method according to claim 2, wherein the application properties includes a list of ports, and wherein the detection of the attack occurs in response to a determination, based on the inspection, that the received packet specifies a port not included in the list of ports.

4. The method according to claim 2, wherein the application properties includes a list of transport protocols, and wherein the detection of the attack occurs in response to a determination, based on the inspection, that the received packet specifies a transport protocol not included in the list of transport protocols.

5. The method according to claim 2, wherein the application properties includes a list of target subnets, and wherein the detection of the attack occurs in response to a determination, based on the inspection, that the received packet specifies a target subnet not included in the list of target subnets.

6. The method according to claim 1, wherein the one or more application properties includes list of predetermined processes of the application, wherein the detection of the attack on the application occurs in response to detection of execution of a process not included in the list of predetermined processes, and wherein the mitigation action includes blocking the process not included in the list of predetermined processes.

7. The method according to claim 1, wherein the one or more application properties includes a list of approved modifications to the application, wherein the detection of the attack on the application occurs in response to detection of a modification to the application not included in the list of approved modifications, and wherein the mitigation action includes blocking the modification to the application not included in the list of approved modifications.

8. The method of claim 1, wherein the detection of the attack on the application occurs in response to a detection of receiving a number packets within a time period that exceeds a threshold, and wherein the mitigation action includes blocking one or more packets received within the time period.

9. The method of claim 8, wherein the detection of the attack on the application occurs in response to a detection of receiving a number packets having a predetermined destination and source within a time period that exceeds a threshold.

10. The method of claim 8, wherein the detection of the attack on the application occurs in response to a detection of receiving a number packets having a predetermined protocol type within a time period that exceeds a threshold.

11. The method of claim 1, further comprising, after deploying the protection program,
determining a new property of the application; and
adjusting one or more rules of the protection program.

12. The method of claim 1, further comprising removing the protection program in response to a determination the application is removed.

13. The method of claim 1, wherein the protection program is an extended Berkley Packet Filter (eBPF).

14. A network node operating in a wireless communication network, the network node comprising:
at least one memory configured to store computer program code; and
at least one processor configured to access said at least one memory and operate as instructed by said computer program code, said computer program code including:
detecting code configured to cause at least one of said at least one processor to detect an onboarding of an application,
determining code configured to cause at least one of said at least one processor to determine one or more application properties of the application in response to the detecting,
generating code configured to cause at least one of said at least one processor to generate a protection program based on the one or more application properties, and
deploying code configured to cause at least one of said at least one processor to deploy the protection program,
wherein the protection program provides a mitigation action in response to a detection of an attack on the application.

15. The network node according to claim 14, wherein the detection of the attack on the application includes the protection program inspecting a received packet, and wherein the mitigation action includes dropping the received packet in response to the detection of the attack based on the inspection.

16. The network node according to claim 15, wherein the application properties includes a list of ports, and wherein the detection of the attack occurs in response to a determination, based on the inspection, that the received packet specifies a port not included in the list of ports.

17. The network node according to claim 15, wherein the application properties includes a list of transport protocols, and wherein the detection of the attack occurs in response to a determination, based on the inspection, that the received packet specifies a transport protocol not included in the list of transport protocols.

18. The network node according to claim 15, wherein the application properties includes a list of target subnets, and wherein the detection of the attack occurs in response to a determination, based on the inspection, that the received packet specifies a target subnet not included in the list of target subnets.

19. The network node according to claim 14, wherein the one or more application properties includes list of predetermined processes of the application, wherein the detection of the attack on the application occurs in response to detection of execution of a process not included in the list of predetermined processes, and wherein the mitigation action includes blocking the process not included in the list of predetermined processes.

20. A non-transitory computer readable medium having instructions stored therein, which when executed by a processor cause the processor to execute a method comprising:
detecting an onboarding of an application;
determining one or more application properties of the application in response to the detecting;
generating a protection program based on the one or more application properties; and
deploying the protection program,
wherein the protection program provides a mitigation action in response to a detection of an attack on the application.
